(19) United States
(12) Patent Application Publication
(10) Pub. No.: US 2026/0145440 A1
(43) Pub. Date: May 28, 2026

(54) PROCESSING SYSTEM AND CONTROL METHOD

(71) Applicant: SEIKO EPSON CORPORATION, Tokyo (JP)

(72) Inventors: Sota HIYAMA, SHIOJIRI-SHI (JP); Takahiro MATSUZAKI, SHIOJIRI-SHI (JP); Tsuneyuki SASAKI, MATSUMOTO-SHI (JP)

(21) Appl. No.: 19/398,350

(22) Filed: Nov. 24, 2025

(30) Foreign Application Priority Data
Nov. 27, 2024 (JP) 2024-206180

(51) Int. Cl. B41J 11/00

(52) U.S. Cl. CPC B41J 11/00212; B41J 11/00216; B41J 11/0022; B41J 11/007; B41J 11/009

(57) ABSTRACT

A processing system is a processing system configured to communicate with a server configured to store characteristic data indicating characteristics of a medium, the processing system including: a feeder configured to feed the medium from a roll; a printer configured to print an image on the medium fed from the feeder; a dryer configured to dry the medium on which the image is printed by the printer; a winder configured to wind the medium dried by the dryer; an imager configured to capture an image of the medium; and a controller configured to acquire a captured image from the imager, and the controller is configured to transmit type data indicating a type of the medium to the server, acquire the characteristic data corresponding to the type indicated by the type data from the server, determine based on the captured image whether the medium is deformed, and control a processing parameter based on the characteristic data when the controller determines that the medium is deformed.

The present application is based on, and claims priority from JP Application Serial Number 2024-206180, filed Nov. 27, 2024, the disclosure of which is hereby incorporated by reference herein in its entirety.

### BACKGROUND

### 1. Technical Field

The present disclosure relates to a processing system and a control method.

### 2. Related Art

JP-A-2000-290882 describes a liquid ejecting apparatus including a conveyance belt that conveys a medium, and an ejector that ejects liquid onto the medium. In the liquid ejecting apparatus, tension is applied to the medium during the conveyance thereof, so that the medium may be deformed. To avoid the deformation, the liquid ejecting apparatus described in JP-A-2000-290882 deforms the printed image in accordance with the deformation of the medium to maintain the printing quality.

JP-A-2000-290882 is an example of the related art.

In the liquid ejecting apparatus described in JP-A-2000-290882, it is assumed that the deformation of the medium is eliminated after the printing operation. When the medium still remains deformed after the printing operation, it is difficult to maintain the printing quality.

### SUMMARY

A processing system according to an aspect of the present disclosure is a processing system configured to communicate with a server configured to store characteristic data indicating characteristics of a medium, the processing system including: a feeder configured to feed the medium from a roll; a printer configured to print an image on the medium fed from the feeder; a dryer configured to dry the medium on which the image is printed by the printer; a winder configured to wind the medium dried by the dryer; an imager configured to capture an image of the medium; and a controller configured to acquire a captured image from the imager, wherein the printer includes a conveyance belt configured to convey the medium, a heating roller configured to press the medium against the conveyance belt while heating the medium, and an ejector configured to eject liquid onto the medium conveyed by the conveyance belt, the dryer includes a heating portion configured to heat the medium, and the controller is configured to transmit type data indicating a type of the medium to the server, acquire the characteristic data corresponding to the type indicated by the type data from the server, determine based on the captured image whether the medium is deformed, and control a processing parameter based on the characteristic data when the controller determines that the medium is deformed.

A control method according to another aspect of the present disclosure is a control method used by a controller to control a processing system configured to process a medium, wherein the controller is configured to: acquire type data indicating a type of the medium, acquire characteristic data indicating characteristics of the medium indicated by the type data, acquire a captured image showing the medium, and control a processing parameter of the processing system based on the characteristic data when it is determined based on the captured image that the medium is deformed.

### BRIEF DESCRIPTION OF THE DRAWINGS

FIG. 1 is a diagrammatic view of a processing system.

FIG. 2 is a diagrammatic view of the processing system and a server.

FIG. 3 shows a first pattern formed by a protective liquid.

FIG. 4 shows a second pattern formed by the protective liquid.

FIG. 5 is a flowchart showing an example of a correction process.

### DESCRIPTION OF EMBODIMENTS

An embodiment of a processing system and a control method will be described below with reference to the drawings.

### Processing System

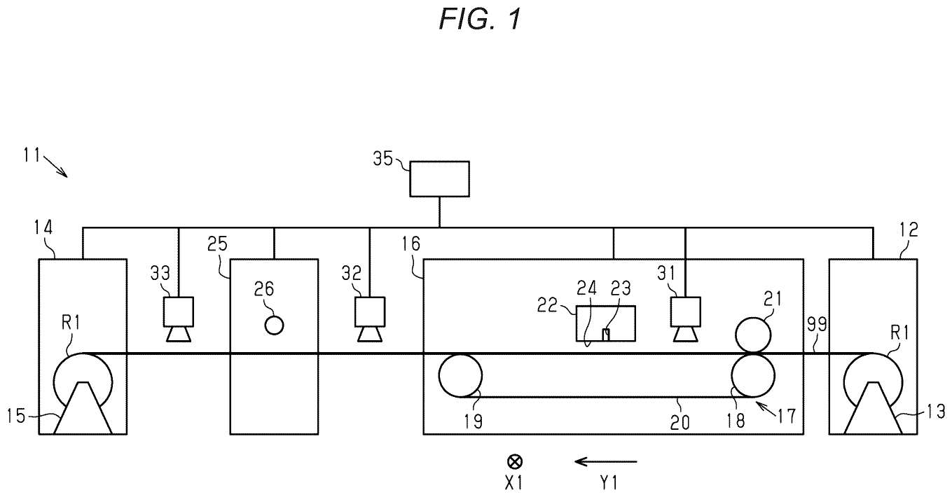

FIG. 1 shows a processing system 11 that is a system configured to process a medium 99. The medium 99 is, for example, fabric. The processing system 11 is configured to perform processing, such as printing operation and drying operation, on the medium 99. The processing system 11 is configured to perform at least one of the printing operation and the drying operation. The processing system 11 may be a system that performs only the printing operation, a system that performs only the drying operation, or a system that performs both the printing operation and the drying operation.

The processing system 11 includes a feeder 12. The feeder 12 is configured to feed the medium 99. In detail, the feeder 12 is configured to feed the medium 99 from a roll R1. The medium 99 is wound to form the roll R1. The feeder 12 feeds the elongated medium 99 from the roll R1 before processed.

The feeder 12 includes a feeding mechanism 13. The feeding mechanism 13 is configured to hold the roll R1. The feeding mechanism 13 is configured to rotate the roll R1. The feeding mechanism 13 includes, for example, a rotary shaft that supports the roll R1, a motor that rotates the roll R1, and other elements.

The feeder 12 feeds the medium 99 while applying back tension to the medium 99. The feeder 12 adjusts the back tension applied to the medium 99, for example, by adjusting the speed at which the medium 99 is fed. When the back tension increases, the medium 99 is strongly stretched. The back tension eliminates any slack of the medium 99. The feeder 12 can thus feed the medium 99 while maintaining an appropriate posture thereof.

The processing system 11 includes a winder 14. The winder 14 is configured to wind the medium 99. The winder 14 winds the medium 99 having been processed by the processing system 11. The winder 14 winds the medium 99 to form the roll R1.

The winder 14 includes a winding mechanism 15. The winding mechanism 15 is configured to hold the roll R1. The winding mechanism 15 is configured to rotate the roll R1. The winding mechanism 15 includes, for example, a rotary shaft that supports the roll R1, a motor that rotates the roll R1, and other elements.

The winder 14 winds the medium 99 while applying tension to the medium 99. The winder 14 adjusts the tension applied to the medium 99, for example, by adjusting the speed at which the medium 99 is wound. When the tension increases, the medium 99 is strongly stretched. The tension eliminates any slack of the medium 99. The winder 14 can thus wind the medium 99 while maintaining an appropriate posture thereof.

The processing system 11 may include a printer 16. The printer 16 is configured to print an image on the medium 99. The printer 16 is configured to print an image on the medium 99 fed from the feeder 12.

The printer 16 includes a conveyer 17. The conveyer 17 is configured to convey the medium 99. The conveyer 17 conveys the medium 99 fed from the feeder 12. The conveyer 17 conveys the medium 99 while holding the medium 99.

The conveyer 17 conveys the medium 99 in a conveyance direction Y1. The conveyance direction Y1 is a direction in which the medium 99 extends. The conveyer 17 conveys the medium 99 from the feeder 12 toward the winder 14.

The conveyer 17 includes multiple pulleys. In an example, the conveyer 17 includes a first pulley 18 and a second pulley 19. The first pulley 18 and the second pulley 19 are configured to rotate. For example, one of the first pulley 18 and the second pulley 19 is configured to rotate as a driving pulley, and the other is configured to rotate as a driven pulley.

The conveyer 17 includes a conveyance belt 20. The conveyance belt 20 is configured to convey the medium 99. In detail, the conveyance belt 20 is configured to convey the medium 99 while holding the medium 99. The conveyance belt 20 has an adhesive layer. In detail, the conveyance belt 20 has an adhesive layer at a surface thereof. The adhesive layer is made of an adhesive. The conveyance belt 20 holds the medium 99 with the medium 99 bonded to the adhesive layer. When the conveyance belt 20 holds the medium 99, back tension acts on the medium 99 between the conveyance belt 20 and the feeder 12. When the conveyance belt 20 holds the medium 99, tension acts on the medium 99 between the conveyance belt 20 and the winder 14. The conveyance belt 20 engages with the multiple pulleys. The conveyance belt 20 rotationally moves as the pulleys rotate. The conveyance belt 20 rotationally moves to convey the medium 99.

The printer 16 includes a heating roller 21. The heating roller 21 is configured to press the medium 99 against the conveyance belt 20 while heating the medium 99. The heating roller 21 includes, for example, a roller that presses the medium 99 against the conveyance belt 20, and a heater that heats the roller. In an example, the heating roller 21 presses the medium 99 against a portion of the conveyance belt 20 that is the portion that engages with the first pulley 18. The heating roller 21 bonds the medium 99 to the conveyance belt 20 by pressing the medium 99 against the conveyance belt 20 while heating the medium 99.

The printer 16 is configured to change a pressurizing force applied by the heating roller 21. The printer 16 changes the pressurizing force, for example, by changing the position of the heating roller 21. When the pressurizing force increases, the medium 99 is likely to come into close contact with the conveyance belt 20.

The printer 16 is configured to change a heating temperature at which the heating roller 21 heats the medium 99. The printer 16 changes the heating temperature, for example, by changing the output of the heater built in the heating roller 21. When the heating temperature rises, the medium 99 is likely to come into close contact with the conveyance belt 20.

The printer 16 is configured to change a pressurization period for which the heating roller 21 pressurizes the medium 99. The printer 16 changes the pressurizing period by changing a conveyance speed at which the conveyance belt 20 is conveyed. When the conveyance speed at which the conveyance belt 20 is conveyed decreases, the pressurizing period lengthens. When the pressurization period lengthens, the medium 99 is likely to come into close contact with the conveyance belt 20.

The printer 16 includes an ejector 22. The ejector 22 is configured to eject liquid. The ejector 22 ejects the liquid onto the medium 99 conveyed by the conveyance belt 20. The ejector 22 has a nozzle surface 24, at which at least one nozzle 23 opens. The ejector 22 is a head that ejects the liquid via the nozzle 23. In an example, the ejector 22 is a serial head that scans the medium 99. The ejector 22 may instead be a line head capable of simultaneously ejecting the liquid across the width of the medium 99.

The ejector 22 is configured to eject a printing liquid. The printing liquid is a liquid with which an image is printed. The printing liquid is, for example, ink. The ejector 22 may be configured to eject a protective liquid. The protective liquid is a liquid that protects an image. The protective liquid is, for example, an overcoat liquid. The protective liquid hardens when it dries. The ejector 22 ejects the printing liquid onto the medium 99 and then ejects the protective liquid.

The ejector 22 is located to face the conveyance belt 20. The ejector 22 is so located that the nozzle surface 24 faces the conveyance belt 20. The ejector 22 is located, for example, directly above the conveyance belt 20. The ejector 22 ejects the liquid onto the medium 99 located on the conveyance belt 20. After the printing operation, the medium 99 is pulled by the winder 14 so that the medium 99 is peeled off the conveyance belt 20.

The ejector 22 is located downstream of the heating roller 21 in the conveyance direction Y1. That is, the heating roller 21 is located upstream of the ejector 22 in the conveyance direction Y1. The ejector 22 ejects the liquid onto the medium 99 heated and pressurized by the heating roller 21 and therefore bonded to the conveyance belt 20.

The processing system 11 may include a dryer 25. The dryer 25 is configured to dry the medium 99. The dryer 25 is configured to dry the medium 99 on which the printing operation has been performed by the printer 16. The medium 99 dried by the dryer 25 is wound around the winder 14.

The dryer 25 includes a heating portion 26. The heating portion 26 is configured to heat the medium 99. The heating portion 26 heats the medium 99 to facilitate evaporation of the liquid ejected onto the medium 99. The image is thus fixed to the medium 99. The heating portion 26 is, for example, an infrared heater. The heating portion 26 may include a blower that blows warm air. The heating portion 26 may include a reflection plate that reflects infrared rays.

The dryer 25 is configured to be capable of changing a drying temperature. The dryer 25 raises the drying temperature, for example, by increasing the output of the heating portion 26. When the drying temperature rises, the medium 99 is likely to dry.

The dryer 25 is configured to be capable of changing a drying period. The dryer 25 changes the drying period by changing the conveyance speed, at which the conveyance belt 20 is conveyed. The dryer 25 changes the conveyance speed by communicating with the printer 16. When the conveyance speed decreases, the drying period lengthens. When the drying period lengthens, the medium 99 is likely to dry.

The processing system 11 includes one or more imagers. In an example, the processing system 11 includes a first imager 31, a second imager 32, and a third imager 33. The imagers are each configured to capture an image of the medium 99. The imagers are each configured to capture an image of the medium 99 across the entire width thereof. The imagers each capture an image of the medium 99 to output the captured image. The captured image is an electronic image showing the medium 99. The first imager 31 captures an image of the medium 99 to output a first captured image. The second imager 32 captures an image of the medium 99 to output a second captured image. The third imager 33 captures an image of the medium 99 to output a third captured image.

The multiple imagers are configured to capture images of the medium 99 in different states. The multiple imagers may capture images of the medium 99 in a state before the printing operation, after the printing operation, before the drying operation, and after the drying operation. The medium 99 before the printing operation has, for example, a state in which the medium 99 has been bonded to the conveyance belt 20 but the printing operation has not been performed. The medium 99 after the printing operation but before the drying operation has a state after the printing operation but before the drying operation. The medium 99 after the printing operation may, for example, have a state in which the medium 99 has been bonded to the conveyance belt 20 and the printing operation has been performed. The medium 99 before the drying operation may, for example, have a state in which the medium 99 has been peeled off the conveyance belt 20 but has not dried. The medium 99 after the printing operation and the medium 99 before the drying operation may have the same state. The medium 99 after the drying operation has a state in which the medium 99 has dried.

The first imager 31 may be configured to capture an image of the medium 99 before the printing operation. In this case, the first captured image shows the medium 99 before the printing operation. The first imager 31 is located, for example, in the printer 16. The first imager 31 is located between the heating roller 21 and the ejector 22 in the conveyance direction Y1. The first imager 31 captures an image of the medium 99 on the conveyance belt 20. The first imager 31 captures an image of the medium 99 after pressed against the heating roller 21 but before the liquid is ejected from the ejector 22.

The second imager 32 may be configured to capture an image of the medium 99 after the printing operation. The second imager 32 may be configured to capture an image of the medium 99 before the drying operation. The second captured image shows the medium 99 after the printing operation but before the drying operation. The second imager 32 is located, for example, between the ejector 22 and the heating portion 26 in the conveyance direction Y1. In an example, the second imager 32 captures an image of the medium 99 after peeled off from the conveyance belt 20. The second imager 32 may capture an image of the medium 99 before peeled off the conveyance belt 20. The second imager 32 may be located in the printer 16.

The third imager 33 may be configured to capture an image of the medium 99 after the drying operation. In this case, the third captured image shows the medium 99 after the drying operation. The third imager 33 is located, for example, downstream of the heating portion 26 in the conveyance direction Y1. In an example, the third imager 33 is located between the dryer 25 and the winder 14 in the conveyance direction Y1. The third imager 33 captures an image of the medium 99 having been dried by the dryer 25 but not having been wound around the winder 14.

The first imager 31, the second imager 32, and the third imager 33 have different names only for the purpose of identification, and the names thereof are not determined by the positions thereof. For example, the first imager 31 may be an apparatus that captures an image of the medium 99 after the printing operation but before the drying operation, or may be an apparatus that captures an image of the medium 99 after the drying operation. The second imager 32 may be an apparatus that captures an image of the medium 99 before the printing operation, or may be an apparatus that captures an image of the medium 99 after the drying operation. The third imager 33 may be an apparatus that captures an image of the medium 99 before the printing operation, or may be an apparatus that captures an image of the medium 99 after the printing operation but before the drying operation.

The processing system 11 may include a controller 35. The controller 35 is configured to control the processing system 11. In detail, the controller 35 is configured to control the feeder 12, the winder 14, the printer 16, the dryer 25, the imagers, and other elements. The controller 35 may be a personal computer possessed by a user, or a computer built in the printer 16. The controller 35 may be an apparatus outside the processing system 11.

The controller 35 may be configured with at least one processor that performs various types of processing in accordance with a computer program. The controller 35 may be configured with at least one dedicated hardware circuit that performs at least some of the various types of processing, such as an ASIC. The controller 35 may be configured with a circuit including the combination of the processor and the hardware circuit. The processor includes a CPU and a memory such as a RAM and a ROM. The memory stores program codes or instructions configured to cause the CPU to perform the processing. The memory, that is, a computer readable medium includes any readable medium that can be accessed by a general-purpose or dedicated computer.

The controller 35 is configured to control processing parameters. The processing parameters are parameters related to the processing performed on the medium 99. The processing parameters are parameters set when the processing system 11 processes the medium 99. The processing parameters include a feeding parameter set in the feeder 12, a winding parameter set in the winder 14, a printing parameter set in the printer 16, a drying parameter set in the dryer 25, and other parameters.

The feeding parameter includes the back tension applied by the feeder 12. The winding parameter includes the tension applied by the winder 14. The printing parameters include the conveyance speed, at which the conveyance belt 20 is conveyed, the pressurizing force applied by the heating roller 21, the heating temperature, at which the heating roller 21 performs the heating operation, the pressurizing period, for which the heating roller 21 performs the pressurizing operation, a protective pattern formed by the protective liquid, and other factors. The pressurizing period, for which the heating roller 21 performs the pressurizing operation, changes in accordance with the conveyance speed, at which the conveyance belt 20 is conveyed. The printing parameter therefore includes the conveyance speed. The drying parameter includes the heating period for which the heating portion 26 performs the heating operation, a heating temperature at which the heating portion 26 performs the heating operation, and other factors. The heating period, for which the heating portion 26 performs the heating operation, varies in accordance with the conveyance speed. It can therefore be said that the drying parameter includes the conveyance speed.

In the processing system 11, the medium 99 may be deformed during the processing. For example, when the heating roller 21 bonds the medium 99 to the conveyance belt 20, the medium 99 may be deformed due to the medium 99 that skews, wrinkles, floats, twists, or otherwise behaves. For example, when the dryer 25 dries the medium 99, the medium 99 may be deformed due to shrinkage in the conveyance direction Y1 or shrinkage in a width direction X1. The width direction X1 is a direction different from the conveyance direction Y1. The width direction X1 is a direction that serves as an indicator indicating the width of the medium 99. In addition, the medium 99 may be deformed, for example, by expansion of fibers that constitute the medium 99 due to the operation of ejecting the liquid onto the medium 99, or a stretch of the fibers due to the operation of peeling the medium 99 off the conveyance belt 20.

In the processing system 11, the medium 99 may experience temporary deformation that is eliminated after the processing, permanent deformation that remains after the processing, or other deformation. For example, deformation of the medium 99 that skews, wrinkles, floats, twists, or otherwise behaves when the medium 99 is attached to the conveyance belt 20 is the temporary deformation. When the printing operation is performed in a state in which any of the types of deformation occurs, there is a concern that the image is distorted. For example, deformation due to shrinkage caused by the operation of drying the medium 99 is the permanent deformation. The permanent deformation affects the quality of the medium 99. It is therefore preferable in the processing system 11 that the processing parameters are so controlled that the medium 99 is not deformed.

A deformation tendency of the medium 99 may vary depending on the characteristics of the medium 99. The characteristics of the medium 99 include the physical properties of the medium 99. The characteristics of the medium 99 correspond to the type of the medium 99. For example, depending on the characteristics of the medium 99, the medium 99 may be likely to be deformed due to small back tension applied by the feeder 12. Depending on the characteristics of the medium 99, the medium 99 may be likely to be deformed due to a small pressurizing force applied by the heating roller 21. Depending on the characteristics of the medium 99, the medium 99 may be likely to be deformed due to a short pressurizing period for which the heating roller 21 pressurizes the medium 99. Depending on the characteristics of the medium 99, the medium 99 may be likely to be deformed due to a short heating period for which the heating roller 21 heats the medium 99. Depending on the characteristics of the medium 99, the medium 99 may be likely to be deformed due to a high drying temperature at which the dryer 25 dries the medium 99. Depending on the characteristics of the medium 99, the medium 99 may be likely to be deformed due to a long drying period for which the dryer 25 dries the medium 99. It is therefore preferable that the processing system 11 controls the processing parameters in accordance with the characteristics of the medium 99 in a way that the medium 99 is not deformed.

The controller 35 is configured to acquire captured images from the imagers. The controller 35 acquires the first captured image from the first imager 31. The controller 35 acquires the second captured image from the second imager 32. The controller 35 acquires the third captured image from the third imager 33.

The controller 35 is configured to determine whether the medium 99 has been deformed based on the captured images. The controller 35 determines whether the medium 99 has been deformed by analyzing the captured images. The controller 35 may determine whether the medium 99 has been deformed, for example, by detecting an edge from any of the captured images. The controller 35 determines whether the medium 99 before the printing operation has been deformed based on the first captured image. The controller 35 determines whether the medium 99 after the printing operation but before the drying operation has been deformed based on the second captured image. The controller 35 determines whether the medium 99 after the drying operation has been deformed based on the third captured image.

When the controller 35 determines based on any of the captured images that the medium 99 has been deformed, the controller 35 grasps a cause of the deformation of the medium 99. When the controller 35 determines based, for example, on the first captured image that the medium 99 has been deformed, the controller 35 can grasp that the medium 99 has been deformed due to the operation of bonding the medium 99 to the conveyance belt 20. When the controller 35 determines based, for example, on the second captured image that the medium 99 has been deformed, the controller 35 can grasp that the medium 99 has been deformed due to the operation of bonding the medium 99 to the conveyance belt 20, the printing operation performed on the medium 99, the operation of peeling the medium 99 off the conveyance belt 20, or any other operation. When the controller 35 determines based, for example, on the third captured image that the medium 99 has been deformed, the controller 35 can grasp that the medium 99 has been deformed due to the operation of bonding the medium 99 to the conveyance belt 20, the printing operation performed on the medium 99, the operation of peeling the medium 99 off the conveyance belt 20, the operation of drying the medium 99, or any other operation.

The controller 35 may determine whether the medium 99 has been deformed based on multiple captured images. The controller 35 may determine whether the medium 99 has been deformed by comparing multiple captured images with each other. When the controller 35 determines based on multiple captured images that the medium 99 has been deformed, the controller 35 may grasp causes of the deformation of the medium 99. The controller 35 may determine whether the medium 99 has been deformed, for example, by comparing the first and second captured images with each other. When the controller 35 determines based on the first and second captured images that the medium 99 has been deformed, the controller 35 can grasp that the medium 99 has been deformed due to the printing operation. The controller 35 may determine whether the medium 99 has been deformed, for example, by comparing the second and third captured images with each other. When the controller 35 determines based on the second and third captured images that the medium 99 has been deformed, the controller 35 can grasp that the medium 99 has been deformed due to the drying operation.

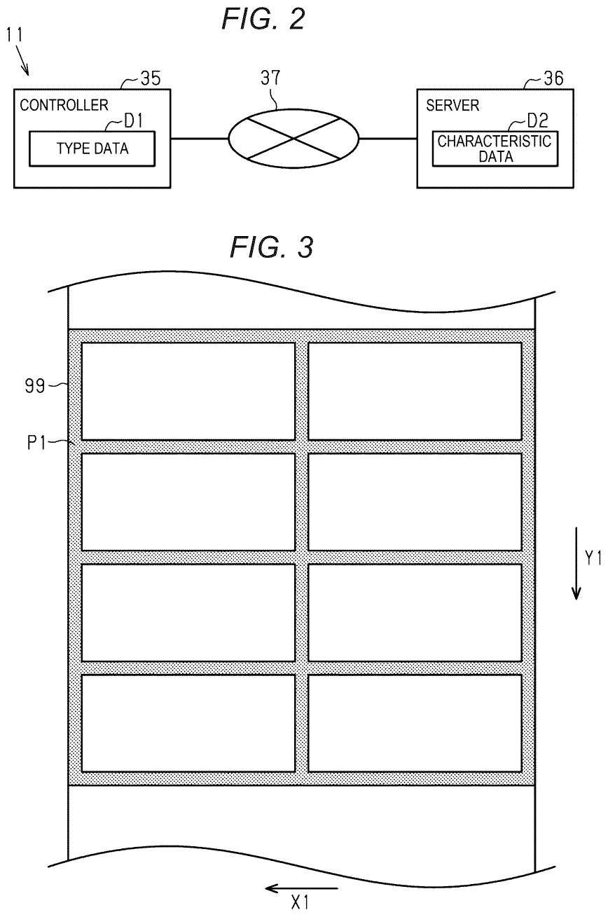

The controller 35 is configured to acquire type data D1, as shown in FIG. 2. The controller 35 acquires the type data D1 based, for example, on the user's input. The controller 35 may acquire the type data D1 by measuring the roll R1 set in the feeder 12. The type data D1 is data indicating the type of the medium 99. The type data D1 may be data indicating the composition of the medium 99, or data indicating the name the fabric of which the medium 99 is made. The type data D1 may be data indicating a material name such as cotton, wool, or polyester, or may be data indicating a weaving method such as plain weaving or twill weaving.

The controller 35 is configured to communicate with a server 36. That is, the processing system 11 is configured to communicate with the server 36. The controller 35 and the server 36 are connected to a network 37. The controller 35 communicates with the server 36 via the network 37. The network 37 is a communication network including a LAN, a WAN, or any other network. The network 37 may be the same as or different from a communication network connected to the feeder 12, the winder 14, the printer 16, the dryer 25, the imagers, the controller 35, and other elements in the processing system 11. The controller 35 is configured to transmit the type data D1 to the server 36.

The server 36 includes a memory that stores a program, and a processor that performs processing in accordance with the program. The memory includes a ROM, a RAM, and other memories. The memory may include a storage medium such as an HDD or an SSD. The processor may include a CPU, a GPU, an MPU, or any other processing unit. The server 36 is configured to communicate with the processing system 11. The server 36 accepts the type data D1 from the controller 35.

The server 36 stores characteristic data D2. The characteristic data D2 is data indicating the characteristics of the medium 99. The characteristic data D2 may contain data indicating the physical properties of the medium 99. The characteristic data D2 may contain, for example, data indicating the stretchability of the medium 99. The characteristic data D2 may contain, for example, data indicating the heat resistance of the medium 99. The characteristic data D2 may contain, for example, data indicating the thickness of the medium 99.

The characteristic data D2 may contain data indicating the deformation tendency of the medium 99. The characteristic data D2 may contain data indicating conditions under which the medium 99 is likely to be deformed. The characteristic data D2 may contain data indicating the likelihood that the drying operation performed by the dryer 25 deforms the medium 99. The characteristic data D2 may contain data indicating how much the drying period for which the dryer 25 dries the medium 99 affects the deformation of the medium 99. The characteristic data D2 may contain data indicating how much the drying temperature at which the dryer 25 dries the medium 99 affects the deformation of the medium 99. The characteristic data D2 may contain, for example, data indicating that the medium 99 is likely to be deformed when the drying temperature is high, or data indicating that the medium 99 is likely to be deformed when the drying period is long.

The server 36 stores a database including the characteristic data D2 on the characteristics of various types of media 99. The characteristic data D2 is associated with the type data D1. In detail, the characteristic data D2 is associated with the type of the medium 99 indicated by the type data D1. When accepting the type data D1, the server 36 identifies the characteristic data D2 corresponding to the type of the medium 99 indicated by the type data D1.

The server 36 is configured to transmit the characteristic data D2 to the controller 35. In detail, the server 36 transmits the characteristic data D2 corresponding to the type of the medium 99 indicated by the type data D1 to the controller 35.

The controller 35 acquires the characteristic data D2. In detail, the controller 35 acquires the characteristic data D2 corresponding to the type indicated by the acquired type data D1 from the server 36. The controller 35 accepts the characteristic data D2 transmitted from the server 36.

The controller 35 controls the processing parameters based on the characteristic data D2. In detail, when the controller 35 determines that the medium 99 has been deformed, the controller 35 controls the processing parameters based on the characteristic data D2. When the controller 35 determines that the medium 99 has been deformed, the controller 35 controls the processing parameters to suppress the deformation of the medium 99. That is, the controller 35 controls the processing parameters to suppress the deformation in accordance with the cause of the deformation of the medium 99.

When the controller 35 determines that the medium 99 before the printing operation has been deformed, and the characteristic data D2 indicates that the medium 99 has large stretchability, the controller 35 may control the processing parameters to lengthen the pressurization period. In detail, when the controller 35 determines based on the first captured image that the medium 99 has been deformed, and further determines based on the characteristic data D2 that the medium 99 is likely to stretch or shrink, the controller 35 may reduce the speed at which the conveyance belt 20 is conveyed. When the pressurization period lengthens, the medium 99 is likely to come into close contact with the conveyance belt 20. The medium 99 before the printing operation is thus less likely to be deformed.

When the controller 35 determines that the medium 99 before the printing operation has been deformed, and the characteristic data D2 indicates that the medium 99 has small stretchability, the controller 35 may control the processing parameters to increase the back tension. In detail, when the controller 35 determines based on the first captured image that the medium 99 has been deformed, and further determines based on the characteristic data D2 that the medium 99 is unlikely to stretch or shrink, the controller 35 may increase the back tension applied to the medium 99 by the feeder 12. When the back tension increases, the medium 99 is likely to come into close contact with the conveyance belt 20. The medium 99 before the printing operation is thus less likely to be deformed. When the medium 99 has large stretchability, there is a concern that increasing the back tension stretches the medium 99. In this case, there is a concern that the increased back tension encourages the deformation of the medium 99.

When the controller 35 determines that the medium 99 before the printing operation has been deformed, and the characteristic data D2 indicates that the medium 99 has a large thickness, the controller 35 may control the processing parameters to increase the pressurizing force. In detail, when the controller 35 determines based on the first captured image that the medium 99 has been deformed, and further determines based on the characteristic data D2 that the medium 99 has a large thickness, the controller 35 may increase the pressurizing force applied by the heating roller 21. When the pressurizing force increases, the medium 99 is likely to come into close contact with the conveyance belt 20. The medium 99 before the printing operation is thus less likely to be deformed. When the medium 99 has a large thickness, and when the pressurizing force is small, the medium 99 is unlikely to come into close contact with the conveyance belt 20.

When the controller 35 determines that the medium 99 before the printing operation has been deformed, and the characteristic data D2 indicates that the medium 99 is large stretchability, the controller 35 may control the processing parameters to raise the heating temperature. In detail, when the controller 35 determines based on the first captured image that the medium 99 has been deformed, and further determines based on the characteristic data D2 that the medium 99 is likely to stretch or shrink, the controller 35 may raise the heating temperature at which the heating roller 21 heats the medium 99. When the heating temperature rises, the medium 99 is likely to come into close contact with the conveyance belt 20. The medium 99 before the printing operation is thus less likely to be deformed.

When the controller 35 determines that the medium 99 after the drying operation has been deformed, and the characteristic data D2 indicates that a long drying period is likely to deform the medium 99, the controller 35 may control the processing parameters to shorten the drying period. In detail, when the controller 35 determines based on the second and third captured images that the medium 99 has been deformed, and further determines based on the characteristic data D2 that a long drying period is likely to deform the medium 99, the controller 35 may reduce the conveyance speed at which the conveyance belt 20 conveys the medium 99. As the conveyance speed decreases, the drying period shortens. When the drying period shortens, the medium 99 is unlikely to shrink. The medium 99 after the drying operation is therefore less likely to be deformed. When the drying period shortens, there is a concern that the operation of drying the medium 99 is insufficient. To avoid the insufficient drying operation, the controller 35 may not only shorten the drying period but also raise the drying temperature.

When the controller 35 determines that the medium 99 after the drying operation has been deformed, and the characteristic data D2 indicates that a high drying temperature is likely to deform the medium 99, the controller 35 may control the processing parameters to lower the drying temperature. In detail, when the controller 35 determines based on the second and third captured images that the medium 99 has been deformed, and further determines based on the characteristic data D2 that a high drying temperature is likely to deform the medium 99, the controller 35 may lower the drying temperature. When the drying temperature lowers, the medium 99 is unlikely to shrink. The medium 99 after the drying operation is therefore less likely to be deformed. When the drying temperature lowers, there is a concern that the operation of drying the medium 99 is insufficient. To avoid the insufficient drying operation, the controller 35 may not only lower the drying temperature but also lengthen the drying period.

When the controller 35 determines that the medium 99 after the drying operation has been deformed, and the characteristic data D2 indicates that the medium 99 has small stretchability, the controller 35 may control the processing parameters to increase the tension. In detail, when the controller 35 determines based on the second and third captured images that the medium 99 has been deformed, and further determines based on the characteristic data D2 that the medium 99 is unlikely to stretch or shrink, the controller 35 may increase the tension applied by the winder 14. When the tension increases, the medium 99 is pulled and therefore is unlikely to shrink. The medium 99 after the drying operation is therefore less likely to be deformed.

When the controller 35 determines that the medium 99 after the drying operation has been deformed, and the characteristic data D2 indicates that the drying operation is likely to deform the medium 99, the controller 35 may control the processing parameters to print a protective pattern formed by a protective liquid. In detail, when the controller 35 determines based on the second and third captured images that the medium 99 has been deformed, and further determines based on the characteristic data D2 that the drying operation performed by the dryer 25 is likely to deform the medium 99, the controller 35 may print a protective pattern formed by a protective liquid onto the medium 99. The protective pattern is a pattern that suppresses shrinkage of the medium 99. The protective pattern may, for example, be a lattice pattern, a grid pattern, or an annular pattern. When the protective liquid hardens as the drying operation is performed, shrinkage of the medium 99 is suppressed. The medium 99 after the drying operation is therefore less likely to be deformed.

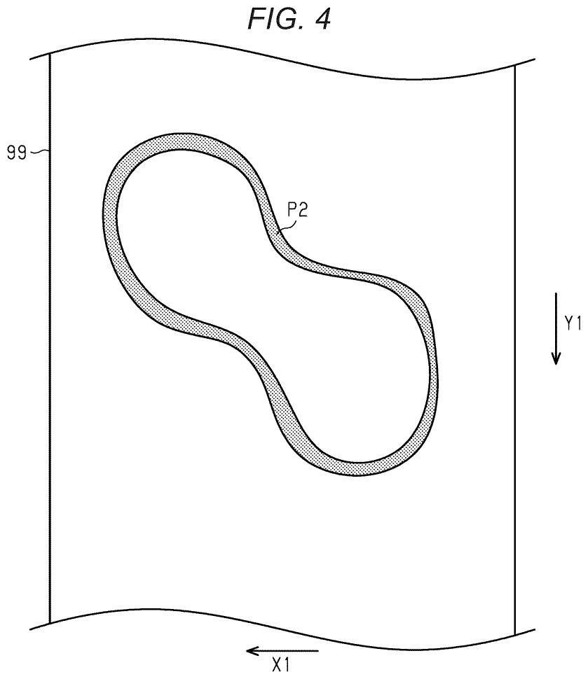

The controller 35 prints the protective pattern in accordance with the deformed region of the medium 99, as shown in FIGS. 3 and 4. In an example, the protective pattern includes a first pattern P1 and a second pattern P2. The first pattern P1 is a pattern printed across the entire medium 99. The second pattern P2 is a pattern printed at a portion of the medium 99.

The controller 35 may print the first pattern P1 or the second pattern P2 on the medium 99 in accordance with the deformed region of the medium 99 after the drying operation. In detail, the controller 35 may determine whether the medium 99 has been entirely deformed or locally deformed based on the second and third captured images. When the controller 35 determines that the medium 99 has been entirely deformed, the controller 35 may print the first pattern P1 on the medium 99. When the controller 35 determines that the medium 99 has been locally deformed, the controller 35 may print the second pattern P2 on the medium 99. In this case, the controller 35 may print the annular second pattern P2 in accordance with the edge of the deformed portion. The medium 99 after the drying operation is therefore less likely to be deformed.

### Control Method

How the controller 35 controls the processing system 11 will next be described.

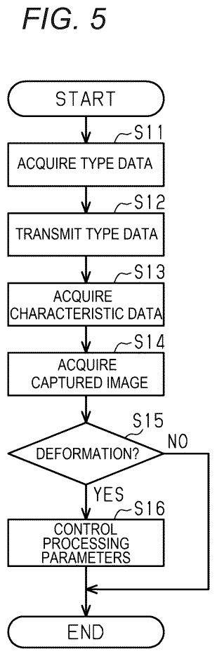

The controller 35 carries out a correction process, as shown in FIG. 5. The controller 35 controls the operation of the processing system 11 by carrying out the correction process. The correction process is the process of controlling the processing parameters to suppress deformation of the medium 99. The controller 35 corrects the processing parameters by carrying out the correction process. The correction process is carried out during the printing operation. The correction process may be repeatedly carried out during the printing operation. The correction process may be carried out at a predetermined cycle during the printing operation.

In step S11, the controller 35 acquires the type data D1.

In step S12, the controller 35 transmits the type data D1 to the server 36.

In step S13, the controller 35 acquires the characteristic data D2. In this step, the controller 35 acquires from the server 36 the characteristic data D2 corresponding to the type data D1 transmitted in step S12.

In step S14, the controller 35 acquires a captured image. In this step, the controller 35 may acquire the first captured image, the second captured image, or the third captured image. The controller 35 may acquire the first and second captured images, may acquire the second and third captured images, may acquire the third and first captured images, or may acquire the first, second, and third captured images.

In step S15, the controller 35 determines whether the medium 99 has been deformed based on the captured image. In this step, the controller 35 may determine the deformation based on the first captured image, based on the second captured image, or based on the third captured image. The controller 35 may determine the deformation based on the first and second captured images, based on the second and third captured images, based on the third and first captured images, or based on the first, second, and third captured images. The controller 35 not only determines the deformation of the medium 99 but also grasps a cause of the deformation of the medium 99.

When the controller 35 determines in step S15 that the medium 99 has been deformed, the controller 35 advances the correction process to step S16. When the controller 35 determines that the medium 99 has not been deformed, the controller 35 terminates the correction process.

In step S16, the controller 35 controls the processing parameters. In detail, the controller 35 controls the processing parameters based on the characteristic data D2 acquired in step S13. In more detail, the controller 35 controls the processing parameters to suppress the deformation of the medium 99 in accordance with the cause of the deformation of the medium 99 grasped in step S15. The controller 35 may increase the back tension, lengthen the pressurizing period, reduce the pressurizing force, or raise the heating temperature in accordance with the cause of the deformation of the medium 99. The controller 35 may lower the drying temperature, shorten the drying period, or print the protective pattern in accordance with the cause of the deformation of the medium 99. A portion of the elongated medium 99 that is a portion located upstream in the conveyance direction Y1 is thus less likely to be deformed than a portion of the elongated medium 99 that is a portion located downstream in the conveyance direction Y1.

### Effects and Advantages of Embodiment Described Above

Effects and advantages of the embodiment described above will next be described.
(1) The controller 35 transmits the type data D1 to the server 36. The controller 35 acquires from the server 36 the characteristic data D2 corresponding to the type indicated by the type data D1. The controller 35 determines whether the medium 99 has been deformed based on the first captured image. When the controller 35 determines that the medium 99 has been deformed, the controller 35 controls the processing parameters based on the characteristic data D2. According to the configuration described above, the processing system 11 can process the medium 99 with appropriate processing parameters according to the characteristics of the medium 99. The deformation of the medium 99 is thus suppressed.
(2) When the controller 35 determines based on the first captured image that the medium 99 has been deformed, and further determines based on the characteristic data D2 that the medium 99 is likely to stretch or shrink, the controller 35 reduces the conveyance speed at which the conveyance belt 20 conveys the medium 99. In the processing system 11, when the conveyance speed decreases, the pressurization period for which the heating roller 21 heats the medium 99 lengthens. When the pressurization period lengthens, the medium 99 is likely to come into close contact with the conveyance belt 20. Therefore, according to the configuration described above, the processing system 11 can suppress the deformation of the medium 99 by reducing the conveyance speed.
(3) When the controller 35 determines based on the first captured image that the medium 99 has been deformed, and further determines based on the characteristic data D2 that the medium 99 is unlikely to stretch or shrink, the controller 35 increases the back tension applied to the medium 99 by the feeder 12. In the processing system 11, when the back tension increases, the medium 99 is likely to come into close contact with the conveyance belt 20. Therefore, according to the configuration described above, the processing system 11 can suppress the deformation of the medium 99 by increasing the back tension.
(4) When the controller 35 determines based on the first captured image that the medium 99 has been deformed, and further determines based on the characteristic data D2 that the medium 99 has a large thickness, the controller 35 increases the pressurizing force applied by the heating roller 21. In the processing system 11, when the pressurizing force increases, the medium 99 is likely to come into close contact with the conveyance belt 20. Therefore, according to the configuration described above, the processing system 11 can suppress the deformation of the medium 99 by increasing the pressurizing force.
(5) When the controller 35 determines based on the first captured image that the medium 99 has been deformed, and further determines based on the characteristic data D2 that the medium 99 is likely to stretch or shrink, the controller 35 raises the heating temperature at which the heating roller 21 heats the medium 99. In the processing system 11, when the heating temperature rises, the medium 99 is likely to come into close contact with the conveyance belt 20. Therefore, according to the above configuration, the processing system 11 can suppress the deformation of the medium 99 by raising the heating temperature.
(6) When the controller 35 determines based on the second and third captured images that the medium 99 has been deformed, and further determines based on the characteristic data D2 that a long drying period is likely to deform the medium 99, the controller 35 increases the speed at which the conveyance belt 20 conveys the medium 99. When the controller 35 determines based on the second and third captured images that the medium 99 has been deformed, it is highly possible that the medium 99 has been deformed due to the drying operation. In the processing system 11, when the conveyance speed increases, the drying period for which the dryer 25 dries the medium 99 shortens. When the drying period shortens, deformation of the medium 99 that is likely to be deformed due to a long drying period is suppressed. Therefore, according to the configuration described above, the processing system 11 can suppress the deformation of the medium 99 by increasing the conveyance speed.
(7) When the controller 35 determines based on the second and third captured images that the medium 99 has been deformed, and further determines based on the characteristic data D2 that a high drying temperature is likely to deform the medium 99, the controller 35 lowers the drying temperature. When the controller 35 determines based on the second and third captured images that the medium 99 has been deformed, it is highly possible that the medium 99 has been deformed due to the drying operation. In the processing system 11, when the drying temperature lowers, deformation of the medium 99 that is likely to be deformed due to a high drying temperature is suppressed. Therefore, according to the configuration described above, the processing system 11 can suppress the deformation of the medium 99 by lowering the drying temperature.
(8) When the controller 35 determines based on the second and third captured images that the medium 99 has been deformed, and further determines based on the characteristic data D2 that the drying operation performed by the dryer 25 is likely to deform the medium 99, the controller 35 prints the protective pattern formed by the protective liquid on the medium 99. When the controller 35 determines based on the second and third captured images that the medium 99 has been deformed, it is highly possible that the medium 99 has been deformed due to the drying operation. In the processing system 11, the protective liquid hardens when dried by the dryer 25. Therefore, according to the configuration described above, the processing system 11 can suppress the deformation of the medium 99 by hardening the protective liquid printed in the form of the protective pattern.
(9) The controller 35 determines based on the second and third captured images whether the medium 99 is entirely deformed or the medium 99 is locally deformed. When the controller 35 determines that the medium 99 has been entirely deformed, the controller 35 prints the first pattern P1 on the medium 99. When the controller 35 determines that the medium 99 has been locally deformed, the controller 35 prints the second pattern P2 on the medium 99. According to the configuration described above, the processing system 11 can print an appropriate protective pattern according to how the medium 99 is deformed. The deformation of the medium 99 is thus appropriately suppressed.

### Variations

The embodiment described above can be implemented in the form of variations as will be described below. The embodiment described above and the following variations can be implemented in combination to the extent that no technical contradictions occur.

The processing system 11 may be a system including the server 36. The controller 35 may include the server 36. The controller 35 may store the characteristic data D2.

In the correction process, the controller 35 may determine that the medium 99 has been deformed and then transmit the type data D1 to the server 36.

The controller 35 may transmit the captured images to the server 36. The server 36 may determine based on the captured images whether the medium 99 has been deformed. The server 36 may transmit the result of the determination to the controller 35.

### Technical Ideas

Technical ideas grasped from the embodiment and the variations described above and effects and advantages of the technical ideas will be described below.
(A) A processing system is a processing system configured to communicate with a server configured to store characteristic data indicating characteristics of a medium, the processing system including: a feeder configured to feed the medium from a roll; a printer configured to print an image on the medium fed from the feeder; a dryer configured to dry the medium on which the image is printed by the printer; a winder configured to wind the medium dried by the dryer; an imager configured to capture an image of the medium; and a controller configured to acquire a captured image from the imager, wherein the printer includes a conveyance belt configured to convey the medium, a heating roller configured to press the medium against the conveyance belt while heating the medium, and an ejector configured to eject liquid onto the medium conveyed by the conveyance belt, the dryer includes a heating portion configured to heat the medium, and the controller is configured to transmit type data indicating a type of the medium to the server, acquire the characteristic data corresponding to the type indicated by the type data from the server, determine based on the captured image whether the medium is deformed, and control a processing parameter based on the characteristic data when the controller determines that the medium is deformed. According to the configuration described above, the processing system can process the medium with an appropriate processing parameter according to the characteristics of the medium. The deformation of the medium is thus suppressed.
(B) In the processing system described above, the characteristic data may contain data indicating stretchability of the medium, and the controller may be configured to reduce a conveyance speed at which the conveyance belt conveys the medium when the controller determines based on the captured image that the medium is deformed, and further determines based on the characteristic data that the medium is likely to stretch or shrink. In the processing system, when the conveyance speed decreases, the pressurization period for which the heating roller heats the medium lengthens. When the pressurization period lengthens, the medium is likely to come into close contact with the conveyance belt. Therefore, according to the configuration described above, the processing system can suppress the deformation of the medium by reducing the conveyance speed.
(C) In the processing system described above, the characteristic data may contain data indicating stretchability of the medium, and the controller may be configured to increase back tension applied to the medium by the feeder when the controller determines based on the captured image that the medium is deformed, and further determines based on the characteristic data that the medium is unlikely to stretch or shrink. In the processing system, when the back tension increases, the medium is likely to come into close contact with the conveyance belt. Therefore, according to the configuration described above, the processing system can suppress the deformation of the medium by increasing the back tension.
(D) In the processing system described above, the characteristic data may contain data indicating a thickness of the medium, and the controller may be configured to increase a pressurizing force applied by the heating roller when the controller determines based on the captured image that the medium is deformed, and further determines based on the characteristic data that the medium has a large thickness. In the processing system, when the pressurizing force increases, the medium is likely to come into close contact with the conveyance belt. Therefore, according to the configuration described above, the processing system can suppress the deformation of the medium by increasing the pressurizing force.
(E) In the processing system described above, the characteristic data may contain data indicating stretchability of the medium, and the controller may be configured to raise a heating temperature at which the heating roller heats the medium when the controller determines based on the captured image that the medium is deformed, and further determines based on the characteristic data that the medium is likely to stretch or shrink. In the processing system, when the heating temperature rises, the medium is likely to come into close contact with the conveyance belt. Therefore, according to the above configuration, the processing system can suppress the deformation of the medium by raising the heating temperature.
(F) In the processing system described above, the imager may be a first imager, the captured image may be a first captured image, the processing system may include a second imager configured to capture an image of the medium, and a third imager configured to capture an image of the medium, the first imager may be located between the heating roller and the ejector in a conveyance direction in which the medium is conveyed, the second imager may be located between the ejector and the heating portion in the conveyance direction, the third imager may be located downstream of the heating portion in the conveyance direction, the characteristic data contains data indicating how much a drying period for which the dryer dries the medium affects the deformation of the medium, and the controller may be configured to acquire a second captured image from the second imager, acquire a third captured image from the third imager, and increase a conveyance speed at which the conveyance belt conveys the medium when the controller determines based on the second and third captured images that the medium is deformed, and further determines based on the characteristic data that the medium is likely to be deformed when the drying period is long. When the controller determines based on the second and third captured images that the medium has been deformed, it is highly possible that the medium has been deformed due to the drying operation. In the processing system, when the conveyance speed increases, the drying period for which the dryer dries the medium shortens. When the drying period shortens, deformation of a medium that is likely to be deformed due to a long drying period is suppressed. Therefore, according to the configuration described above, the processing system can suppress the deformation of the medium by increasing the conveyance speed.
(G) In the processing system described above, the imager may be a first imager, the captured image may be a first captured image, the processing system may include a second imager configured to capture an image of the medium, and a third imager configured to capture an image of the medium, the first imager may be located between the heating roller and the ejector in a conveyance direction in which the medium is conveyed, the second imager may be located between the ejector and the heating portion in the conveyance direction, the third imager may be located downstream of the heating portion in the conveyance direction, the characteristic data may contain data indicating how much a drying temperature at which the dryer dries the medium affects the deformation of the medium, and the controller may be configured to acquire a second captured image from the second imager, acquire a third captured image from the third imager, and lower the heating temperature when the controller determines based on the second and third captured images that the medium is deformed, and further determines based on the characteristic data that the medium is likely to be deformed when the drying temperature is high. When the controller determines based on the second and third captured images that the medium has been deformed, it is highly possible that the medium has been deformed due to the drying operation. In the processing system, when the drying temperature lowers, deformation of a medium that is likely to be deformed due to a high drying temperature is suppressed. Therefore, according to the configuration described above, the processing system can suppress the deformation of the medium by lowering the drying temperature.
(H) In the processing system described above, the imager may be a first imager, the captured image may be a first captured image, the ejector may be configured to eject a printing liquid with which the image is printed, and a protective liquid configured to protect the image, the processing system may include a second imager configured to capture an image of the medium, and a third imager configured to capture an image of the medium, the first imager may be located between the heating roller and the ejector in a conveyance direction in which the medium is conveyed, the second imager may be located between the ejector and the heating portion in the conveyance direction, the third imager may be located downstream of the heating portion in the conveyance direction, the characteristic data may contain data indicating how much the drying operation performed by the dryer affects the deformation of the medium, and the controller may be configured to acquire a second captured image from the second imager, acquire a third captured image from the third imager, and print a protective pattern on the medium with the protective liquid when the controller determines based on the second and third captured images that the medium is deformed, and further determines based on the characteristic data that the medium is likely to be deformed by the drying operation performed by the dryer. When the controller determines based on the second and third captured images that the medium has been deformed, it is highly possible that the medium has been deformed due to the drying operation. In the processing system, the protective liquid hardens when dried by the dryer. Therefore, according to the configuration described above, the processing system can suppress the deformation of the medium by hardening the protective liquid printed in the form of the protective pattern.
(I) In the processing system described above, the controller may be configured to determine based on the second and third captured images whether the medium is entirely deformed or locally deformed, print a first pattern out of the protection pattern on the medium when the controller determines that the medium is entirely deformed, and print a second pattern different from the first pattern out of the protection pattern on the medium when the controller determines that the medium is locally deformed. According to the configuration described above, the processing system can print an appropriate protective pattern according to how the medium is deformed. The deformation of the medium is thus appropriately suppressed.
(J) A control method is a method used by a controller to control a processing system configured to process a medium, and the controller may be configured to acquire type data indicating a type of the medium, acquire characteristic data indicating characteristics of the medium indicated by the type data, acquire a captured image showing the medium, and control a processing parameter of the processing system based on the characteristic data when it is determined based on the captured image that the medium is deformed. According to the method described above, the processing system can process the medium with an appropriate processing parameter according to the characteristics of the medium. The deformation of the medium is thus suppressed.

What is claimed is:

1. A processing system configured to communicate with a server configured to store characteristic data indicating characteristics of a medium, the processing system comprising:
a feeder configured to feed the medium from a roll;
a printer configured to print an image on the medium fed from the feeder;
a dryer configured to dry the medium on which the image is printed by the printer;
a winder configured to wind the medium dried by the dryer;
an imager configured to capture an image of the medium; and
a controller configured to acquire a captured image from the imager,
wherein the printer includes
a conveyance belt configured to convey the medium,
a heating roller configured to press the medium against the conveyance belt while heating the medium, and
an ejector configured to eject liquid onto the medium conveyed by the conveyance belt,
the dryer includes a heating portion configured to heat the medium, and
the controller is configured to
transmit type data indicating a type of the medium to the server,
acquire the characteristic data corresponding to the type indicated by the type data from the server,
determine based on the captured image whether the medium is deformed, and
control a processing parameter based on the characteristic data when the controller determines that the medium is deformed.

2. The processing system according to claim 1, wherein
the characteristic data contains data indicating stretchability of the medium, and
the controller is configured to reduce a conveyance speed at which the conveyance belt conveys the medium when the controller determines based on the captured image that the medium is deformed, and further determines based on the characteristic data that the medium is likely to stretch or shrink.

3. The processing system according to claim 1, wherein
the characteristic data contains data indicating stretchability of the medium, and
the controller is configured to increase back tension applied to the medium by the feeder when the controller determines based on the captured image that the medium is deformed, and further determines based on the characteristic data that the medium is unlikely to stretch or shrink.

4. The processing system according to claim 1, wherein
the characteristic data contains data indicating a thickness of the medium, and
the controller is configured to increase a pressurizing force applied by the heating roller when the controller determines based on the captured image that the medium is deformed, and further determines based on the characteristic data that the medium has a large thickness.

5. The processing system according to claim 1, wherein
the characteristic data contains data indicating stretchability of the medium, and
the controller is configured to raise a heating temperature at which the heating roller heats the medium when the controller determines based on the captured image that the medium is deformed, and further determines based on the characteristic data that the medium is likely to stretch or shrink.

6. The processing system according to claim 1, wherein
the imager is a first imager,
the captured image is a first captured image,
the processing system includes
a second imager configured to capture an image of the medium, and
a third imager configured to capture an image of the medium,
the first imager is located between the heating roller and the ejector in a conveyance direction in which the medium is conveyed,
the second imager is located between the ejector and the heating portion in the conveyance direction,
the third imager is located downstream of the heating portion in the conveyance direction,
the characteristic data contains data indicating how much a drying period for which the dryer dries the medium affects the deformation of the medium, and
the controller is configured to
acquire a second captured image from the second imager,
acquire a third captured image from the third imager, and
increase a conveyance speed at which the conveyance belt conveys the medium when the controller determines based on the second and third captured images that the medium is deformed, and further determines based on the characteristic data that the medium is likely to be deformed when the drying period is long.

7. The processing system according to claim 1, wherein
the imager is a first imager,
the captured image is a first captured image,
the processing system includes
a second imager configured to capture an image of the medium, and
a third imager configured to capture an image of the medium,
the first imager is located between the heating roller and the ejector in a conveyance direction in which the medium is conveyed,
the second imager is located between the ejector and the heating portion in the conveyance direction,
the third imager is located downstream of the heating portion in the conveyance direction,
the characteristic data contains data indicating how much a drying temperature at which the dryer dries the medium affects the deformation of the medium, and
the controller is configured to
acquire a second captured image from the second imager,
acquire a third captured image from the third imager, and
lower the heating temperature when the controller determines based on the second and third captured images that the medium is deformed, and further determines based on the characteristic data that the medium is likely to be deformed when the drying temperature is high.

8. The processing system according to claim 1, wherein
the imager is a first imager,
the captured image is a first captured image,
the ejector is configured to eject a printing liquid with which the image is printed, and a protective liquid configured to protect the image,
the processing system includes
a second imager configured to capture an image of the medium, and
a third imager configured to capture an image of the medium,
the first imager is located between the heating roller and the ejector in a conveyance direction in which the medium is conveyed,
the second imager is located between the ejector and the heating portion in the conveyance direction,
the third imager is located downstream of the heating portion in the conveyance direction,
the characteristic data contains data indicating how much the drying operation performed by the dryer affects the deformation of the medium, and
the controller is configured to
acquire a second captured image from the second imager,
acquire a third captured image from the third imager, and
print a protective pattern on the medium with the protective liquid when the controller determines based on the second and third captured images that the medium is deformed, and further determines based on the characteristic data that the medium is likely to be deformed by the drying operation performed by the dryer.

9. The processing system according to claim 8, wherein
the controller is configured to
determine based on the second and third captured images whether the medium is entirely deformed or locally deformed,
print a first pattern out of the protection pattern on the medium when the controller determines that the medium is entirely deformed, and
print a second pattern different from the first pattern out of the protection pattern on the medium when the controller determines that the medium is locally deformed.

10. A control method used by a controller to control a processing system configured to process a medium, wherein the controller is configured to:
acquire type data indicating a type of the medium,
acquire characteristic data indicating characteristics of the medium indicated by the type data,
acquire a captured image showing the medium, and
control a processing parameter of the processing system based on the characteristic data when it is determined based on the captured image that the medium is deformed.
